(19) United States
(12) Patent Application Publication
(10) Pub. No.: US 2024/0311642 A1
(43) Pub. Date: Sep. 19, 2024

(54) ACCELERATED ADVERSARIAL TRAINING FOR LARGE-SCALE SOURCE CODE DATASETS VIA FEATURE-SPACE TRANSFORMATION

(71) Applicant: Visa International Service Association, San Francisco, CA (US)

(72) Inventors: Jihye CHOI, Madison, WI (US); Yizhen WANG, Santa Clara, CA (US); Ke WANG, Sunnyvale, CA (US); Sunpreet Singh ARORA, Union City, CA (US)

(73) Assignee: Visa International Service Association, San Francisco, CA (US)

(21) Appl. No.: 18/185,444

(22) Filed: Mar. 17, 2023

(51) Int. Cl. G06N 3/094

(52) U.S. Cl. CPC G06N 3/094

(57) ABSTRACT

The present disclosure describes a method and system for training a robust source code model in a neural network. The neural network trains on a large-scale dataset and adversarial examples to improve the classification accuracy of the source code model. The system generates adversarial examples based on a sequence of transformations, modeled by a mapping function in the feature-space.

### TECHNICAL FIELD

The present disclosure describes an adversarial neural network configured to model adversarial source code transformations with an innovative mapping scheme such that the adversarial neural network is capable of building a robust source code models on from a large scale dataset.

### SUMMARY

In one aspect, the present disclosure describes a method for training an adversarial neural network for source code classification, the method comprising: receiving, by a computing system, an input dataset, wherein the input dataset comprises a plurality of training pairs, wherein each training pair comprises an input program and a ground-truth of interest corresponding to the input program; generating, by the computing system, a feature vector of the input program with a feature extractor; generating, by the computing system, adversarial examples with an attacker model, wherein the adversarial examples are based on the feature vector of the input program, wherein the attacker model comprises a mapping function that approximates a sequence of transformations of the input program in a feature-space, and wherein the adversarial examples are semantically equivalent to the input program; generating, by the computing system, a predicted outcome for the adversarial examples with a machine learning model for source code classification; calculating, by the computing system, a loss by a loss function that compares the predicted outcome to the ground-truth of interest for the input program; updating, by the computing system, the machine learning model according to a learning algorithm with the loss; and determining, by the computing system, a quality metric for the machine learning model, wherein the quality metric is a number of correctly predicted outcome based on the ground-truth of interest for the plurality of training pairs; and determining, by the computing system, the quality metric meets a training threshold, wherein the training threshold indicates a peak accuracy of the predicted outcomes for the adversarial examples.

In yet another aspect, the present disclosure describes a method for training a neural network for generating adversarial examples, the method comprising: receiving, by a computing system, an input dataset, wherein the input dataset comprises a plurality of training pairs, wherein each training pair comprises an input program and a ground-truth of interest corresponding to the input program; generating, by the computing system, a feature vector of the input program with a feature extractor; generating, by the computing system, an approximation of a transformation of the feature vector of the input program, wherein the approximation of the transformation of the feature vector is approximated with a mapping function in a feature-space; generating, by the computing system, a predicted outcome for the approximation of the transformation of the feature vector, with a machine learning model for source code classification; calculating, by the computing system, a loss by a loss function that compares the predicted outcome to the ground-truth of interest for the input program; selecting, by the computing system, a subsequent transformation of the feature vector of the input program based on the loss with a search algorithm; and determining, by the computing system, a sequence of transformations that meets a threshold loss over the plurality of training pairs in the input dataset, and wherein the sequence of transformations comprises a plurality of transformations that prevents the machine learning model from correctly classifying an adversarial example.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 shows a logic flow diagram for training a source code model, g, to predict the ground-truth interests, based on a training dataset, according to at least one aspect of the present disclosure.

FIG. 2 shows a logic flow diagram for adversarial training of a robust machine learning model, g, according to at least one aspect of the present disclosure.

FIG. 3 shows a logic flow diagram for training an attacker model configured to maximize the loss value of the loss function through adversarial examples A(x) in the problem-space for an input program, x, according to at least one aspect of the present disclosure.

FIG. 4 shows a real-world example of a problem-space transformation sequence, configured to generate an adversarial example directly in the problem-space, according to at least one aspect of the present disclosure.

FIG. 5 shows a logic flow diagram of a problem-space attacker model side-by-side to a feature-space attacker model, according to at least one aspect of the present disclosure.

FIG. 6 shows a logic flow diagram for generating a mapping function M_{T} between the feature vector of input program, f(x), and the feature vector of the transformation of input program, f(T(x)), according to at least one aspect of the present disclosure.

FIG. 7 is a block diagram of a computer apparatus with data processing subsystems or components, according to at least one aspect of the present disclosure.

FIG. 8 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

The present disclosure provides a neural networking system for generating adversarial examples for machine learning models. In various aspects, the machine learning models may be trained to identify, label, classify, and/or determine author attribution, for source code. The system generates adversarial examples, for a source code input, that is designed to be misclassified by the models. The system uses the misclassification to identify weaknesses in the current model and retain the model for a more robust classification.

The system employs a neural network to generate the adversarial examples from a sequence of transformation from the original input x (e.g. method, application, program, source code, etc.). The generated transformations are semantic-preserving transformation such that they are functionally and operatively equivalent to the original input. However, unlike traditional problem-space transformations, the present disclosure generates adversarial examples through feature-space transformations. By generating the transformations in the feature-space the system can significantly reduce computation overhead and allows the transformations to be performed on a GPU. Traditional problem-space transformations were required to migrate data from the GPU, perform transformation on a CPU and transfer back to the GPU.

By performing the transformations on directly on the GPU, the system may experience a 10× improvement in training time and transformation sequence generation. This performance improvement allows the system to be implemented on a large-scale datasets for robust model training that was previously impractical for problem-space transformations.

In various aspects, the system generates a sequence of transformations, of an input program, to train a source code classification model. The sequence of transformations combines to provide adversarial examples that improve the classification of the model and prevent circumvention of the classification model.

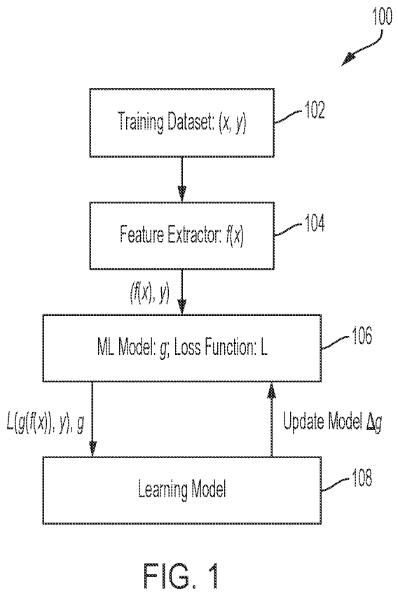

FIG. 1 shows a logic flow diagram 100 for training a source code machine learning (ML) model, g, to predict a ground-truth of interest, based on an input dataset, according to at least one aspect of the present disclosure. The input dataset comprises a plurality of training pairs (x, y) where the x represents the input programs and y represents the ground-truth property of interest associated with input programs, x. The computing system receives 102 the training dataset and executes 104 a feature extractor, f, on the input programs, x, to extract a feature vectors, f(x). The computing system generates 106 the expected outcome according to machine learning (ML) source code model g, and calculates the a loss value according to the loss function. The computing system updates 108 model g according to a learning algorithm and the loss function.

The computing system trains the machine learning (ML) source code model g, by performing a plurality of training epochs of a training loop. The computing system continues the training process of the source code model g, until the system generates g*, where g*f(x)) closely approximates y over all training pairs (x,y), i.e. according to:

$${g}^{*} = arg {min}_{g ∈ ℋ} {( x , y ) \sim D}_{} L ( g ( f ( x ) ) , y )$$

where [symbol] is the hypothesis set, and L is a loss function that penalizes the difference between the predicted value, g*(f(x)), and the ground-truth value, y. In one example, the ground-truth interest or downstream task is a functionality prediction, where y represents the ground-truth functionality group for input x, g(f(x)) is the predicted functionality group for input x, and L is the loss function with a value between 0-1. In each epoch of the training loop, the system calculates 106 the loss function by comparing the predicted outcome or predicted functionality group to the ground truth value or the expected outcome. The system continues the training process until the predicted outcome meets a predetermined training threshold for a quality metric. In various aspects, the system determines the quality metric by comparing the predicted outcome g*(f(A(x))) for the adversarial example, A(x), to the ground-truth value, y, for input x. In one example, the quality metric may determine that the model correctly predicts 95 outcomes out of the last 100 training pairs. Additionally, the loss, determined by the loss function, generally corresponds with the accuracy determined by the quality metric. As the loss decreases the accuracy of the model prediction increases. This relationship will hold true until the loss approaches an asymptotic limit. The loss may begin to plateau and the accuracy may reach a peak value. However, the peak accuracy may be determined as training continues and the accuracy begins to decrease rather than increasing. The decrease in model accuracy may reveals the peak accuracy model as the point just prior to the accuracy decrease. This point represents the number of training epochs needed to place the machine learning model in a state of equilibrium between underfitting the training dataset and overfitting the training dataset. In one example, the predetermined training threshold may be the number of training epochs just prior to the accuracy decrease that reveals the peak model accuracy.

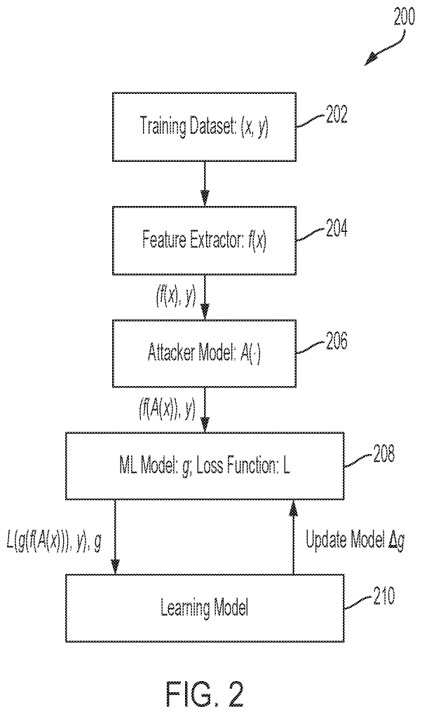

FIG. 2 shows a logic flow diagram 200 for adversarial training of a robust machine learning model, g, according to at least one aspect of the present disclosure. A computing system, such as a server, executes the adversarial training to enhance model robustness in adversarial environments. Adversarial training minimizes the maximum loss over potential adversarial variants of the training inputs. The computing system receives 202 the training dataset and extracts 204 the feature vector, similar to the training system of FIG. 1. During the training process, the learning algorithm simulates an attacker model, A(⋅), where A(x) is the adversarial example created by an attacker model. The system applies 206 the attacker model to the input x to create an adversarial example. The computing system generates 208 the expected outcome according to machine learning (ML) source code model g, and calculates the a loss value according to the loss function. The computing system updates 210 model g according to a learning algorithm and the loss function. The learning algorithm in the adversarial training model uses (A(x),y), instead of using (x,y) as the training input like ML source code model for FIG. 1.

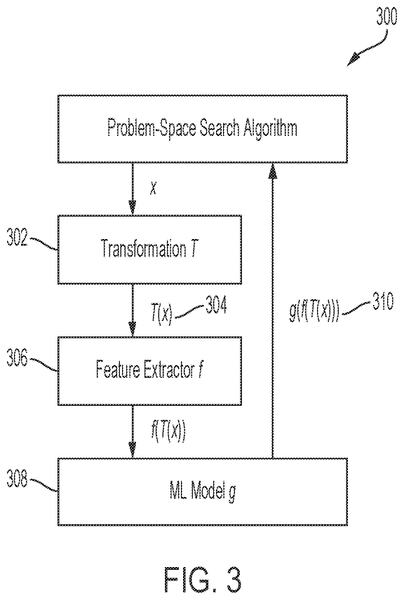

FIG. 3 shows a logic flow diagram 300 for training an attacker model, configured to maximize the loss value of the loss function through adversarial examples A(x) in the problem-space for an input program, x, according to at least one aspect of the present disclosure. The attacker model is configured to search for the sequence of transformations, T, that maximizes the loss value between the predicted ground-truth and the actual ground-truth, y. In various aspect, the attacker model employs a Monte-Carlo Tree Search (MCTS), as the searching algorithm to maximize the loss value of the loss function, L.

The system selects 302 a transformation candidate, T, and applies 304 the transformation candidate to the input on the problem-space, T(x). The system then extracts 306 the feature of the transformed input, f(T(x)), and computes 308 the loss value from the downstream ML model, g. The system uses 310 the loss value to guide the subsequent searches and identify potential transformations in order to maximize the overall loss value. Unfortunately, the searching algorithms can be computationally prohibitive for large-scale datasets (e.g. Project CodeNet) because the searching process invokes a large number of problem-space transformations. In the problem-space, source code transformations are generated much slower than with image model transformation. This difference between image models is primarily due to the difficulty of applying a gradient update of a typical learning algorithm pipeline for source code. Additionally, the searching algorithm becomes the computation bottleneck for the attacker model in the problem-space for source code transformation. Accordingly, it is advantageous to perform the transformations in the feature-space for source code applications.

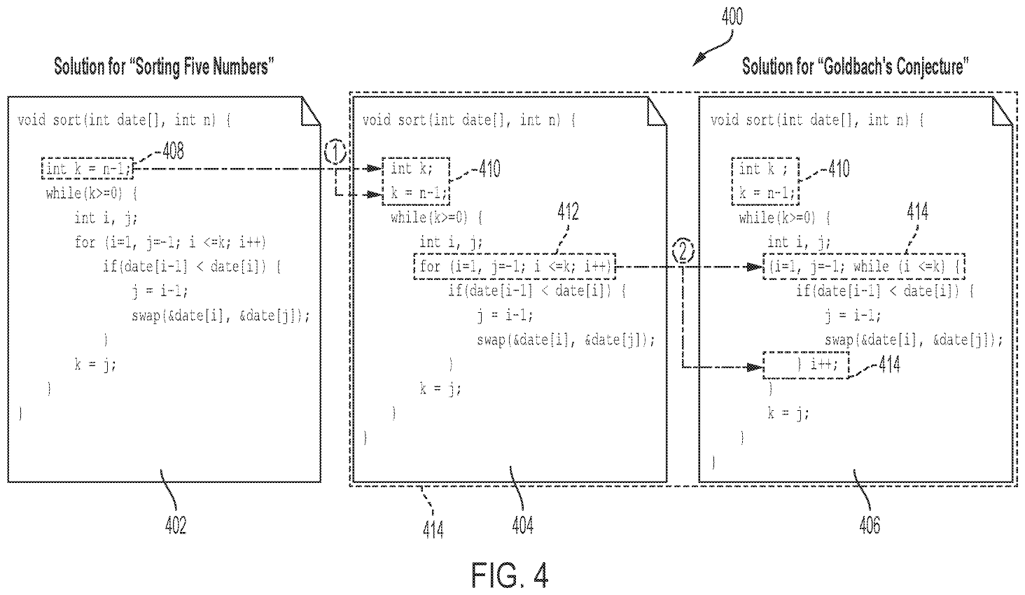

FIG. 4 shows a real-world example of a problem-space transformation sequence 400, configured to generate an adversarial example 406 directly in the problem-space, according to at least one aspect of the present disclosure. In a problem-space transformation, the raw input of the original input program 402, x, is directly manipulated in the problem-space. The source code representation 404 is a first transformation of x, and the source code representation 406 shows a second transformation of x. In this example, the first transformation 404 replaces the initialization statements 408 in the original input 402 with new initialization statements 410. The second transformation 406 replaces the for-loop 412 with a while-loop 414. The second transformation 406 maintains the changes from the first transformation 404 so that each subsequent transformation increases the loss value. In various aspects, all transformations 404, 406, in the sequence 414, are semantically the same as the input program 402. In the example, transformation 406 is semantically equivalent to original input 402 but represents an adversarial example that is incorrectly classified by the source code ML model g.

In various aspects, the computing system executes an attacker model that creates the transformations and ultimately generates the adversarial examples, A(x). The attacker model comprises a set or sequence of transformations [symbol] ={T₁, . . . , Tₖ}, similar to the real world example of FIG. 4, where each Tᵢ in the set transforms input code x to Tᵢ(x). Additionally each transformation Tᵢ(x) and input code x have the same semantics for all i∈[k].

During the execution of the attacker model, the computing system may replace a clean test input x with an adversarial variant x_{adv} in a feasible set [symbol] (x). The feasible set [symbol] (x) is determined by the transformation set, [symbol] . An input x′ is in the feasible set [symbol] (x) where x′ can be obtained by applying a sequence of transformations over x. The input x′ is any variant in the feasible set [symbol] (x), where x_{adv} is the specific variant in the feasibility set that maximizes the loss function. The objective of the attacker model is to find the adversarial variant x_{adv} in [symbol] (x) such that the loss value L(g(f(x_{adv})),y) is maximized, (e.g., making g(f(x_{adv})) different from y). In the functionality prediction example, a maximized loss value means that ML model g will misclassify the functionality group of x. Accordingly, the attacker model determines adversarial examples from the set of transformations, [symbol] , that will be misclassified by model g. In various aspect, the system will train the attacker model until it reaches a loss threshold where the threshold loss is the cumulative maximum loss over all the transformations in the sequence of transformations. The system may then perform adversarial training to train a robust classification model g, and prevent misclassification due to adversarial examples.

However, the computing system expends a significant amount of computation resources in order to execute the attacker model. Specifically, the searching algorithm, such as a MCTS, consumes a significant amount of computation overhead in order to evaluate all transformations. This computational overhead comes from applying the attacker model in the problem-space. In order to perform transformations in the problem-space, the computing system must first compute x→T(x)→f(T(x)), then feed f(T(x)) to the downstream ML source code model, g, and finally obtain the loss value for the next MCTS iteration (e.g. epoch). Accordingly, the present disclosure describes an accelerated training scheme for the creation of adversarial examples, A(x), and reduces the computational overhead experienced from problem-space transformations.

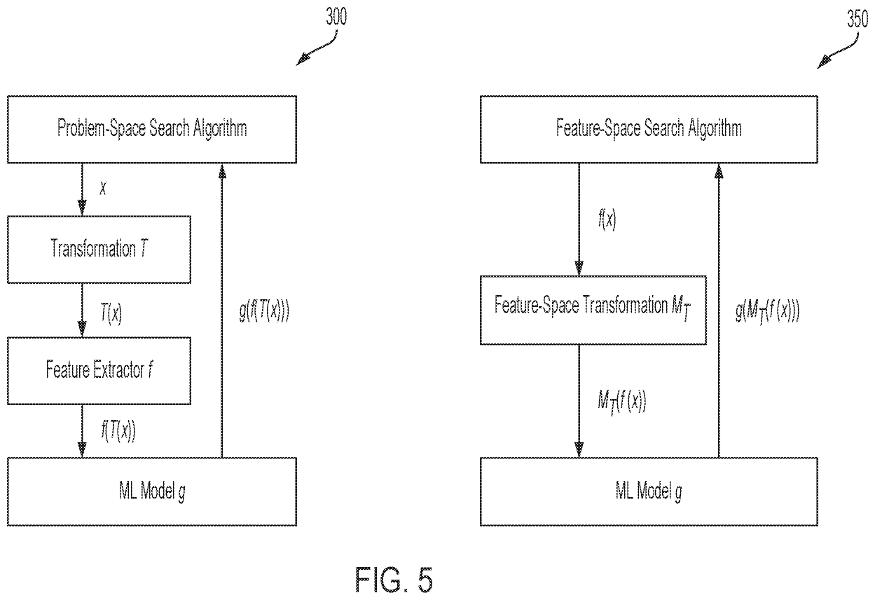

FIG. 5 shows a logic flow diagram of a problem-space attacker model 300 side-by-side to a feature-space attacker model 350, according to at least one aspect of the present disclosure. The feature-space attacker model 350 is configured to circumvent this multi-step process of the problem-space attacker model 300, by directly approximating f(T(x)) based solely on the feature of original input (e.g., f(x)→f(T(x))). The feature-space attacker model 350 employs a mapping function M_{T} that maps the feature of original input x to that of transformed input T(x). The mapping function M_{T} allows the attacker model to skip the computationally extensive operations on the input-space (e.g., T(x)), and replace the feature of transformed input (e.g., f(T(x))) with the approximated feature (e.g., M_{T}(f(x))). Therefore, the mapping function M_{T} accelerates the MCTS searching process, as well as adversarial training for the ML model g.

As shown in the example of FIG. 4, a single transformation T₁ may be insufficient to create an effective adversarial example A(x). A sequence of multiple transformations may be necessary for the transformation to fool the model g. For example, a sequence of transformations may create an effective adversarial example A(x), where A(x)=Tᵢ(Tⱼ(x)) for Tᵢ≠Tⱼ. Accordingly, the computing system determines a mapping for each individual transformation and applies a sequence of those mappings to the feature of original input. The system approximates the feature of the transformed input, where M_{T}_{ᵢ}(M_{T}_{ⱼ})(f(x)))≈f(Tᵢ(Tⱼ(x)). The mapping, M_{T}_{ᵢ}, allows the computing system to closely approximate the transformation in the feature-space without performing each transformation in the problem space.

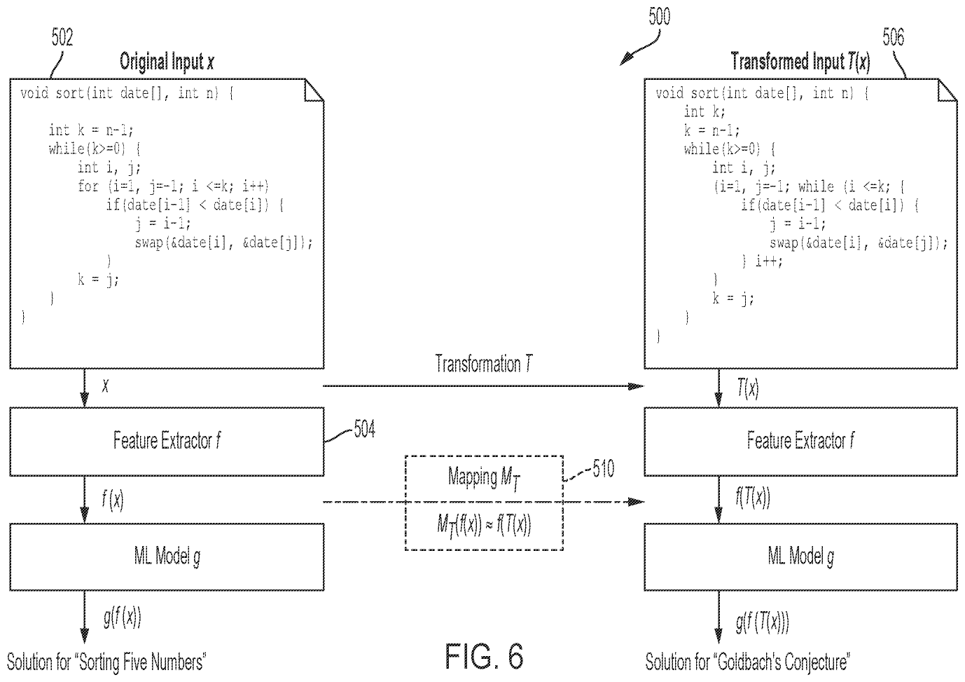

FIG. 6 shows a logic flow diagram 500 for generating a mapping function M_{T} between the feature vector of input program, f(x), and the feature vector of the transformation of input program, f(T(x)), according to at least one aspect of the present disclosure. The system trains a neural network M_{T} to predict a mapping to approximate the transformation according to: M_{T}(f(x))≈f(T(x)). The computing system trains the mapping function, M_{T}, according to:

$${M}_{T} = arg {min}_{M} {x \sim D}_{} L ( M ( f ( x ) ) , f ( T ( x ) ) )$$

where M is the neural network, and L is a loss function that penalizes the difference between M_{T}(f(x)) and f(T(x)). In one aspect, the loss function L may be determined according to a Mean Squared Error function, where,

$${M}_{T} = arg {min}_{M} {x \sim D}_{} {( M ( f ( x ) ) - f ( T ( x ) ) )}^{2} .$$

The computing system solves for M_{T} by employing a feature extractor configured to generate fixed length vectors. The computing system further selects an ML model and learning algorithm such that the mapping function approximates a feature vector of the transformation within a predetermined quality metric.

In various aspects, the feature extractor 604 is convolutional neural network (e.g. C-Bert, Code Bert, etc) configured to generate a fixed length vector from the source code input, x. The fixed length vectors are representative of varying sizes of source code while still preserving the original characteristics of the source code. Additionally, the convolutional neural network may be configured for large-scale datasets and applicable for various domains such as image, natural language, and source codes. In one example, Project CodeNet dataset is a large-scale dataset that comprises over 14 million code samples, over 500 million lines of code, in 55 different programming languages. The computing system is further configured to fine-tune the feature extractor 504 in order to generate representative vectors, based on a large-scale dataset (e.g., Project CodeNet), and the downstream task (e.g., functionality prediction).

The computing system may employ a multi-layer perceptron as the learning algorithm. In one example, the learning algorithm is a five-layer perceptron with kernel sizes of 1024, 512, 256, 512, and 1024. The computing system updates the parameters of the learning algorithm (e.g., weights and biases in a five-layer perceptron) through stochastic gradient descent-based optimization with adaptive learning rate, such as an Adam optimizer learning rate.

The process of determining a mapping function that approximates the original input and the transformed input on the feature-space may be performed by parameterizing the discrete transformation function on the input-space and its impact through the feature extractor. The mapping function M is specific to the feature extractor f and transformation T, but it is not bound to the downstream ML model g.

The computing system further evaluates the quality of the mapping function M to approximate the feature vector of the transformation in feature-space according to a metric:

$${x \sim D}_{} [ g ( {M}_{T} ( f ( x ) ) ) = g ( f ( T ( x ) ) ) ]$$

where the indicator function [symbol] [c] takes the value 1(0) when the condition c is true (false). The computing system may determine that the mapping function is sufficiently trained when the utility of approximated feature toward the downstream task or predicted outcome, remain within a predetermined value or standard deviation of target feature. The computing system may determine that the mapping function meets a threshold accuracy after a predetermined number of predicted outcomes (i.e., g(M_{T}(f(x))), for model g, agree with the target outcomes (i.e., g(f(T(x))))

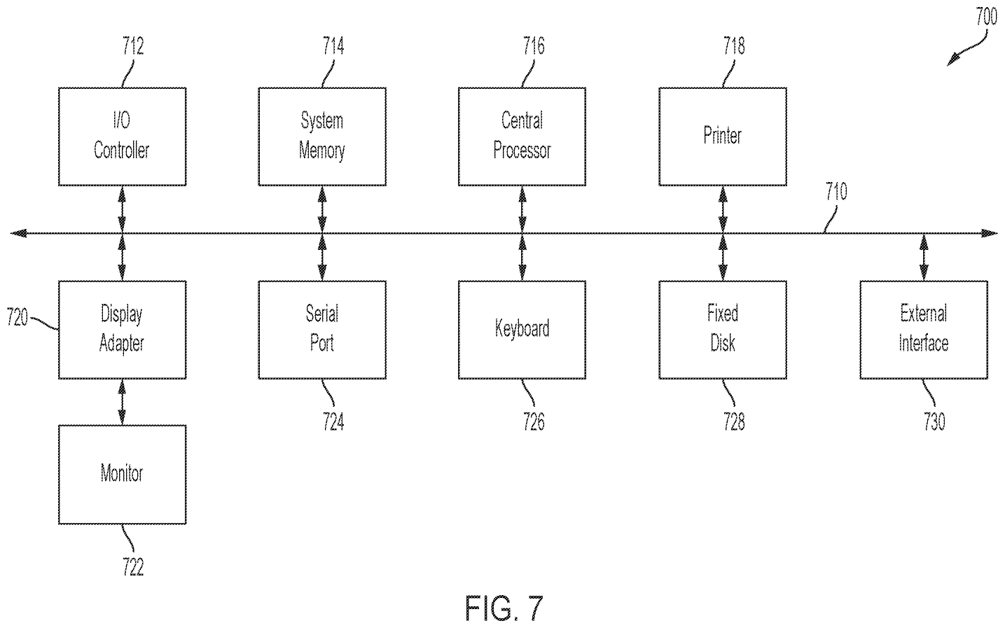

FIG. 7 is a block diagram of a computer apparatus 700 with data processing subsystems or components, according to at least one aspect of the present disclosure. The subsystems shown in FIG. 7 are interconnected via a system bus 710. Additional subsystems such as a printer 718, keyboard 726, fixed disk 728 (or other memory comprising computer readable media), monitor 722, which is coupled to a display adapter 720, and others are shown. Peripherals and input/output (I/O) devices, which couple to an I/O controller 712 (which can be a processor or other suitable controller), can be connected to the computer system by any number of means known in the art, such as a serial port 724. For example, the serial port 724 or external interface 730 can be used to connect the computer apparatus to a wide area network such as the Internet, a mouse input device, or a scanner. The interconnection via system bus allows the central processor 716 to communicate with each subsystem and to control the execution of instructions from system memory 714 or the fixed disk 728, as well as the exchange of information between subsystems. The system memory 714 and/or the fixed disk 428 may embody a computer readable medium.

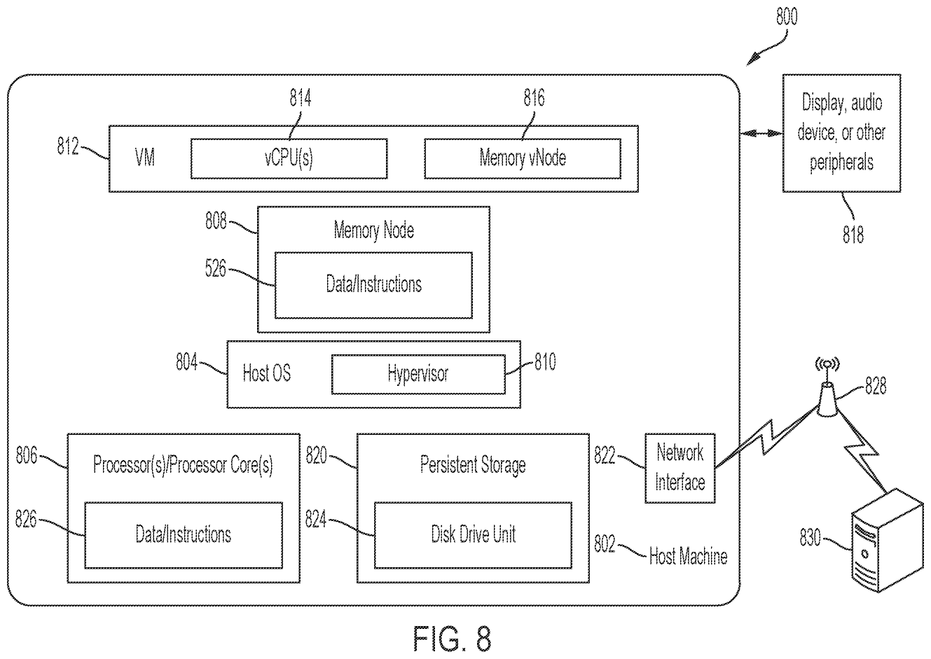

FIG. 8 is a diagrammatic representation of an example system 800 that includes a host machine 802 within which a set of instructions to perform any one or more of the methodologies discussed herein may be executed, according to at least one aspect of the present disclosure. In various aspects, the host machine 802 operates as a standalone device or may be connected (e.g., networked) to other machines. In a networked deployment, the host machine 802 may operate in the capacity of a server or a client machine in a server-client network environment, or as a peer machine in a peer-to-peer (or distributed) network environment. The host machine 802 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 800 includes the host machine 802, running a host operating system (OS) 804 on a processor or multiple processor(s)/processor core(s) 806 (e.g., a central processing unit (CPU), a graphics processing unit (GPU), or both), and various memory nodes 808. The host OS 804 may include a hypervisor 810 which is able to control the functions and/or communicate with a virtual machine (“VM”) 812 running on machine readable media. The VM 812 also may include a virtual CPU or vCPU 814. The memory nodes 808 may be linked or pinned to virtual memory nodes or vNodes 816. When the memory node 808 is linked or pinned to a corresponding vNode 816, then data may be mapped directly from the memory nodes 808 to their corresponding vNodes 816.

All the various components shown in host machine 802 may be connected with and to each other, or communicate to each other via a bus (not shown) or via other coupling or communication channels or mechanisms. The host machine 802 may further include a video display, audio device or other peripherals 818 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 820 (also referred to as disk drive unit), and a network interface device 822. The host machine 802 may further include a data encryption module (not shown) to encrypt data. The components provided in the host machine 802 are those typically found in computer systems that may be suitable for use with aspects of the present disclosure and are intended to represent a broad category of such computer components that are known in the art. Thus, the system 800 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 824 also may be a Solid-state Drive (SSD), a hard disk drive (HDD) or other includes a computer or machine-readable medium on which is stored one or more sets of instructions and data structures (e.g., data/instructions 826) embodying or utilizing any one or more of the methodologies or functions described herein. The data/instructions 826 also may reside, completely or at least partially, within the main memory node 808 and/or within the processor(s) 806 during execution thereof by the host machine 802. The data/instructions 826 may further be transmitted or received over a network 828 via the network interface device 822 utilizing any one of several well-known transfer protocols (e.g., Hyper Text Transfer Protocol (HTTP)).

The processor(s) 806 and memory nodes 808 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 802 and that causes the host machine 802 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 830 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 802, with each server 830 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. A method for training an adversarial neural network for source code classification, the method comprising: receiving, by a computing system, an input dataset, wherein the input dataset comprises a plurality of training pairs, wherein each training pair comprises an input program and a ground-truth of interest corresponding to the input program; generating, by the computing system, a feature vector of the input program with a feature extractor; generating, by the computing system, adversarial examples with an attacker model, wherein the adversarial examples are based on the feature vector of the input program, wherein the attacker model comprises a mapping function that approximates a sequence of transformations of the input program in a feature-space, and wherein the adversarial examples are semantically equivalent to the input program; generating, by the computing system, a predicted outcome for the adversarial examples with a machine learning model for source code classification; calculating, by the computing system, a loss by a loss function that compares the predicted outcome to the ground-truth of interest for the input program; updating, by the computing system, the machine learning model according to a learning algorithm with the loss; and determining, by the computing system, a quality metric for the machine learning model, wherein the quality metric is a number of correctly predicted outcome based on the ground-truth of interest for the plurality of training pairs; and determining, by the computing system, the quality metric meets a training threshold, wherein the training threshold indicates a peak accuracy of the predicted outcomes for the adversarial examples.

Clause 2. The method of Clause 1, wherein the learning algorithm is multi-layer perceptron function, and wherein learning parameters of the learning algorithm are updated according to a stochastic gradient descent-based optimization model.

Clause 3. The method of Clause 2, wherein the learning algorithm comprises an adaptive learning rate according to an Adam optimizer function.

Clause 4. The method of Clauses 2-3, wherein the learning algorithm comprises a five-layer perceptron.

Clause 5. The method of Clause 4, wherein the five-layer perceptron comprises kernel sizes of 1024, 512, 256, 512, and 1024.

Clause 6. The method of Clauses 1-5, wherein the attacker model comprises a search algorithm is a Monte-Carlo Tree Search (MCTS), and wherein the search algorithm that identifies an exhaustive list of transformation for the sequence of transformations of the input program.

Clause 7. The method of Clauses 1-6, wherein the feature extractor is a convolutional neutral network, and wherein the feature extractor is a function of a classification task and the input program.

Clause 8. The method of Clause 7, wherein the classification task is a functionality prediction of source code.

Clause 9. The method of Clauses 1-8, wherein the training threshold is a model accuracy to place the machine learning model in a state of equilibrium between overfitting the training pairs and underfitting the training pairs.

Clause 10. The method of Clauses 1-9, wherein the mapping function is based on the sequence of transformations and the feature extractor.

Clause 11. The method of Clause 1-10, wherein the input dataset is a large-scale dataset comprising more than 500 million of the training pairs.

Clause 12. The method of Clauses 1-11, wherein the loss function is a mean squared error function.

Clause 13. The method of Clauses 1-12, wherein the attacker model is configured to maximize the loss between an expected outcome and the predicted outcome, wherein the expected outcome is the ground-truth of interest for the input program.

Clause 14. A method for training a neural network for generating adversarial examples, the method comprising: receiving, by a computing system, an input dataset, wherein the input dataset comprises a plurality of training pairs, wherein each training pair comprises an input program and a ground-truth of interest corresponding to the input program; generating, by the computing system, a feature vector of the input program with a feature extractor; generating, by the computing system, an approximation of a transformation of the feature vector of the input program, wherein the approximation of the transformation of the feature vector is approximated with a mapping function in a feature-space; generating, by the computing system, a predicted outcome for the approximation of the transformation of the feature vector, with a machine learning model for source code classification; calculating, by the computing system, a loss by a loss function that compares the predicted outcome to the ground-truth of interest for the input program; selecting, by the computing system, a subsequent transformation of the feature vector of the input program based on the loss with a search algorithm; and determining, by the computing system, a sequence of transformations that meets a threshold loss over the plurality of training pairs in the input dataset, and wherein the sequence of transformations comprises a plurality of transformations that prevents the machine learning model from correctly classifying an adversarial example.

Clause 15. The method of Clause 14, wherein the search algorithm is a Monte-Carlo Tree Search (MCTS), and wherein the search algorithm that identifies an exhaustive list of transformation for the sequence of transformations.

Clause 16. The method of Clauses 14-15, wherein the feature extractor is a convolutional neutral network, and wherein the feature extractor is a function of a classification task and the input program.

Clause 17. The method of Clause 16, wherein the classification task is a functionality prediction of source code.

Clause 18. The method of Clause 14-17, wherein the threshold loss is a cumulative maximum loss of the plurality of transformations in the sequence of transformations.

Clause 19. The method of Clauses 14-18, wherein the input dataset is a large-scale dataset comprising more than 500 million of the training pairs.

Clause 20. The method of Clauses 14-19, wherein the loss function is a mean squared error function.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method for training an adversarial neural network for source code classification, the method comprising:
receiving, by a computing system, an input dataset, wherein the input dataset comprises a plurality of training pairs, wherein each training pair comprises an input program and a ground-truth of interest corresponding to the input program;
generating, by the computing system, a feature vector of the input program with a feature extractor;
generating, by the computing system, adversarial examples with an attacker model, wherein the adversarial examples are based on the feature vector of the input program, wherein the attacker model comprises a mapping function that approximates a sequence of transformations of the input program in a feature-space, and wherein the adversarial examples are semantically equivalent to the input program;
generating, by the computing system, a predicted outcome for the adversarial examples with a machine learning model for source code classification;
calculating, by the computing system, a loss by a loss function that compares the predicted outcome to the ground-truth of interest for the input program;
updating, by the computing system, the machine learning model according to a learning algorithm with the loss; and
determining, by the computing system, a quality metric for the machine learning model, wherein the quality metric is a number of correctly predicted outcome based on the ground-truth of interest for the plurality of training pairs; and
determining, by the computing system, the quality metric meets a training threshold, wherein the training threshold indicates a peak accuracy of the predicted outcomes for the adversarial examples.

2. The method of claim 1, wherein the learning algorithm is multi-layer perceptron function, and wherein learning parameters of the learning algorithm are updated according to a stochastic gradient descent-based optimization model.

3. The method of claim 2, wherein the learning algorithm comprises an adaptive learning rate according to an Adam optimizer function.

4. The method of claim 2, wherein the learning algorithm comprises a five-layer perceptron.

5. The method of claim 4, wherein the five-layer perceptron comprises kernel sizes of 1024, 512, 256, 512, and 1024.

6. The method of claim 1, wherein the attacker model comprises a search algorithm is a Monte-Carlo Tree Search (MCTS), and wherein the search algorithm that identifies an exhaustive list of transformation for the sequence of transformations of the input program.

7. The method of claim 1, wherein the feature extractor is a convolutional neutral network, and wherein the feature extractor is a function of a classification task and the input program.

8. The method of claim 7, wherein the classification task is a functionality prediction of source code.

9. The method of claim 1, wherein the training threshold is a model accuracy to place the machine learning model in a state of equilibrium between overfitting the training pairs and underfitting the training pairs.

10. The method of claim 1, wherein the mapping function is based on the sequence of transformations and the feature extractor.

11. The method of claim 1, wherein the input dataset is a large-scale dataset comprising more than 500 million of the training pairs.

12. The method of claim 1, wherein the loss function is a mean squared error function.

13. The method of claim 1, wherein the attacker model is configured to maximize the loss between an expected outcome and the predicted outcome, wherein the expected outcome is the ground-truth of interest for the input program.

14. A method for training a neural network for generating adversarial examples, the method comprising:
receiving, by a computing system, an input dataset, wherein the input dataset comprises a plurality of training pairs, wherein each training pair comprises an input program and a ground-truth of interest corresponding to the input program;
generating, by the computing system, a feature vector of the input program with a feature extractor;
generating, by the computing system, an approximation of a transformation of the feature vector of the input program, wherein the approximation of the transformation of the feature vector is approximated with a mapping function in a feature-space;
generating, by the computing system, a predicted outcome for the approximation of the transformation of the feature vector, with a machine learning model for source code classification;
calculating, by the computing system, a loss by a loss function that compares the predicted outcome to the ground-truth of interest for the input program;
selecting, by the computing system, a subsequent transformation of the feature vector of the input program based on the loss with a search algorithm; and
determining, by the computing system, a sequence of transformations that meets a threshold loss over the plurality of training pairs in the input dataset, and wherein the sequence of transformations comprises a plurality of transformations that prevents the machine learning model from correctly classifying an adversarial example.

15. The method of claim 14, wherein the search algorithm is a Monte-Carlo Tree Search (MCTS), and wherein the search algorithm that identifies an exhaustive list of transformation for the sequence of transformations.

16. The method of claim 14, wherein the feature extractor is a convolutional neutral network, and wherein the feature extractor is a function of a classification task and the input program.

17. The method of claim 16, wherein the classification task is a functionality prediction of source code.

18. The method of claim 14, wherein the threshold loss is a cumulative maximum loss of the plurality of transformations in the sequence of transformations.

19. The method of claim 14, wherein the input dataset is a large-scale dataset comprising more than 500 million of the training pairs.

20. The method of claim 14, wherein the loss function is a mean squared error function.
